(19) United States
(12) Patent Application Publication
(10) Pub. No.: US 2023/0364912 A1
(43) Pub. Date: Nov. 16, 2023

(54) MAINTENANCE ASSEMBLY FOR AN INKJET HEAD, MAINTENANCE METHOD FOR AN INKJET HEAD AND APPARATUS FOR PROCESSING A SUBSTRATE INCLUDING A MAINTENANCE ASSEMBLY FOR AN INKJET HEAD

(71) Applicant: SEMES CO.,LTD., Cheonan-si (KR)

(72) Inventors: Won-Yong JIN, Jeon-si (KR); Hosang LEE, Asan-si (KR); Jiyun AHN, Cheonan-si (KR); Suk-Won JANG, Pyeongtaek-si (KR); Jae-Duck LEE, Seongnam-si (KR)

(73) Assignee: SEMES CO.,LTD., Cheonan-si (KR)

(21) Appl. No.: 18/305,801

(22) Filed: Apr. 24, 2023

(30) Foreign Application Priority Data
May 12, 2022 (KR) 10-2022-0058167

(51) Int. Cl. B41J 2/165; B41J 2/175

(52) U.S. Cl. CPC B41J 2/16532; B41J 2/175

(57) ABSTRACT

A maintenance assembly for an inkjet head may include a housing having an upper face facing a nozzle face on which nozzles for discharging a chemical liquid on a substrate are arranged, and a fluid supplying part for providing a humidity control fluid onto the nozzles and the nozzle face such that a humidity of the nozzles and a humidity of the nozzle face are adjusted to a set humidity if the humidity of the nozzles and the humidity of the nozzle face are different from the set humidity.

### CROSS-REFERENCE TO RELATED APPLICATION

This application claims priority to Korean Patent Application No. 10-2022-0058167 filed on May 12, 2022 in the Korean Intellectual Property Office (KIPO), the contents of which are herein incorporated by reference in its entirety.

### BACKGROUND

### 1. Field

Example embodiments of the invention relate to a maintenance assembly for an inkjet head, a maintenance method for an inkjet head and an apparatus for processing a substrate including a maintenance assembly for an inkjet head. More particularly, example embodiments relate to maintenance assembly for an inkjet head capable of maintaining a nozzle face of an inkjet head to meet predetermined set conditions, a maintenance method for an inkjet head using such a maintenance assembly for an inkjet head, and an apparatus for processing a substrate including the maintenance assembly for an inkjet head.

### 2. Related Technology

To manufacture a display device such as an organic light emitting display (OLED) device or a quantum dot light emitting display (QLED) device, a process for dispensing a liquid chemical onto a substrate, this process for dispensing the liquid chemical may generally be performed using an apparatus for processing a substrate including an inkjet head having a nozzle face on which a plurality of nozzles are arranged.

In the process for dispensing the liquid chemical onto the substrate, a failure of the process may be caused if the chemical liquid remains in the nozzles of the inkjet head or on the nozzle face of the inkjet head. Thus, a maintenance process is performed to clean the chemical liquid remaining in the nozzles or on the nozzle face. In addition, the chemical liquid used for manufacturing the display device may be very sensitive to a surrounding environment including humidity so that the surrounding environment to the chemical liquid is needed to be carefully maintained as well as process conditions including a temperature and/or a humidity to the nozzles and the nozzle face of the inkjet head is needed to maintained.

According to the conventional technology, a maintenance process for removing the chemical liquid remained in the nozzles or the nozzle face of the inkjet head may not be sufficiently performed even though a maintenance process for keeping the process conditions including the temperature and/or the humidity in the nozzles or on the nozzle face may be executed.

### SUMMARY

It is one object of the invention to provide a maintenance assembly for an inkjet head, which can capable of advantageously maintaining process conditions including temperature and humidity for nozzles of the inkjet head and/or a nozzle face of the inkjet head.

It is another object of the invention to provide a maintenance method for an inkjet head, which can capable of advantageously maintaining process conditions including temperature and humidity for nozzles of the inkjet head and/or a nozzle face of the inkjet head.

It is still another object of the invention to provide an apparatus for processing a substrate including a maintenance assembly for an inkjet head capable of advantageously maintaining process conditions including temperature and humidity for nozzles of the inkjet head and/or a nozzle face of the inkjet head.

According to an aspect of the invention, there is provided a maintenance assembly for an inkjet head. The maintenance assembly for an inkjet head may include a housing having an upper face facing a nozzle face on which nozzles for discharging a chemical liquid on a substrate are arranged; and a fluid supplying part for providing a humidity control fluid onto the nozzles and the nozzle face such that a humidity of the nozzles and a humidity of the nozzle face are adjusted to a set humidity if the humidity of the nozzles and the humidity of the nozzle face are different from the set humidity.

In example embodiments, the fluid supplying part may include an inflow line through which the humidity control fluid is provided from an external source, a humidity controlling part for enabling the humidity control fluid to have the set humidity, and a supply line for providing the humidity control fluid having the set humidity onto the nozzles and the nozzle face.

In example embodiment, the humidity controlling part includes a heater for heating the humidity control fluid.

In example embodiment, the maintenance assembly for an inkjet head may additionally include a humidity sensing part for measuring the humidity of the nozzles and the humidity of the nozzle face, wherein the humidity controlling part adjusts the humidity of the humidity control fluid in accordance with results measured by the humidity sensing part.

In example embodiment, the maintenance assembly for an inkjet head may additionally include a fluid distributing part for uniformly distributing the humidity control fluid over the nozzles and the nozzle face wherein the atmosphere distributing part may have a mesh structure.

In example embodiment, the maintenance assembly for an inkjet head may additionally include a guide part for maintaining a constant distance between the upper face of the housing and the nozzle face.

In example embodiment, the maintenance assembly for an inkjet head may additionally include a pressure controlling part for adjusting a pressure of the humidity control fluid, and a fluid discharging part for discharging the humidity control fluid to an outside.

In example embodiment, the humidity control fluid may be selected from an oxygen gas, a nitrogen gas, a clean dried air and combinations thereof. The maintenance assembly may additionally include an oxygen sensing part for measuring an amount of oxygen in the humidity control fluid over the nozzles and the nozzle face, and an amount of the humidity control fluid provided onto the nozzles and the nozzle face is adjusted in accordance with results measured by the oxygen sensing part.

In example embodiment, the maintenance assembly for an inkjet head may additionally include a chemical liquid collecting part for collecting a remaining chemical liquid or a falling chemical liquid from the nozzles and the nozzle face in a vacuum suction manner.

In example embodiment, the chemical liquid collecting part may include a chemical liquid receiving part for receiving the remaining chemical liquid or the falling chemical liquid, a chemical liquid discharging part for temporally storing and discharging the remaining chemical liquid or the falling chemical liquid, and a connection line coupled to the chemical liquid receiving part and the chemical liquid discharging part.

According to another aspect of the invention, there is provided a maintenance method for an inkjet head. The maintenance method for an inkjet head may include measuring a humidity of nozzles for discharging chemical liquid onto a substrate and a humidity of a nozzle face on which the nozzles are arranged, and adjusting the humidity of the nozzles and the humidity of the nozzle face to a set humidity if the measured humidity of the nozzles and the measured humidity of the nozzle face ate different from the set humidity.

In example embodiments, the adjusting of the humidity of the nozzles and the humidity of the nozzle face may include providing a humidity control fluid onto the nozzles and the nozzle face. A humidity of humidity control fluid may be controlled by heating the humidity control fluid and/or by adjusting an amount of the humidity control fluid. The humidity control fluid may be selected from an oxygen gas, a nitrogen gas, a clean dried air and combinations thereof.

In example embodiments, the maintenance method for an inkjet head may additionally include collecting a remaining chemical liquid or a falling chemical liquid from the nozzles and the nozzle face in a vacuum suction manner.

In example embodiments, the adjusting of the humidity of the nozzles and the humidity of the nozzle face may be performed when the nozzles do not discharge the chemical liquid onto the substrate.

According to still another aspect of the invention, there is provided an apparatus for processing a substrate. The apparatus for processing a substrate may include an inkjet head having a nozzle face on which nozzles for discharging a chemical liquid onto a substrate are arranged, and a maintenance assembly for performing a maintenance to the inkjet head. The maintenance assembly may include a housing having an upper face facing the nozzle face, and a fluid supplying part for providing a humidity control fluid onto the nozzles and the nozzle face such that a humidity of the nozzles and a humidity of the nozzle face are adjusted to a set humidity if the humidity of the nozzles and the humidity of the nozzle face are different from the set humidity.

In example embodiments, the fluid supplying part may include an inflow line through which the humidity control fluid is provided from an external source, a humidity controlling part for enabling the humidity control fluid to have the set humidity, and a supply line for providing the humidity control fluid having the set humidity onto the nozzles and the nozzle face.

In example embodiments, the apparatus for processing a substrate may additionally include a humidity sensing part for measuring the humidity of the nozzles and the humidity of the nozzle face, wherein the humidity controlling part may adjust the humidity of the humidity control fluid in accordance with results measured by the humidity sensing part.

In example embodiments, the apparatus for processing a substrate may additionally include a fluid distributing part for uniformly distributing the humidity control fluid over the nozzles and the nozzle face wherein the atmosphere distributing part has a mesh structure, a guide part for maintaining a constant distance between the upper face of the housing and the nozzle face, a pressure controlling part for adjusting a pressure of the humidity control fluid, and a fluid discharging part for discharging the humidity control fluid to an outside.

In example embodiments, the humidity control fluid is selected from an oxygen gas, a nitrogen gas, a clean dried air and combinations thereof. The maintenance assembly may additionally include an oxygen sensing part for measuring an amount of oxygen in the humidity control fluid over the nozzles and the nozzle face. An amount of the humidity control fluid provided onto the nozzles and the nozzle face may be adjusted in accordance with results measured by the oxygen sensing part.

In example embodiments, the apparatus for processing a substrate may additionally include a chemical liquid collecting part for collecting a remaining chemical liquid or a falling chemical liquid from the nozzles and the nozzle face in a vacuum suction manner. The chemical liquid collecting part may include a chemical liquid receiving part for receiving the remaining chemical liquid or the falling chemical liquid, a chemical liquid discharging part for temporally storing and discharging the remaining chemical liquid or the falling chemical liquid, and a connection line coupled to the chemical liquid receiving part and the chemical liquid discharging part.

According to example embodiments, when the process for discharging the chemical liquid onto the substrate from the inkjet head is not performed, the maintenance assembly for the inkjet head may perform the maintenance to the inkjet head so that the nozzles and/or the nozzle face may have the predetermined set humidity. In particular, the humidity in the nozzles and/or on the nozzle face of the inkjet head may be measured, and the humidity in the nozzles and/or on the nozzle face may be adjusted to the predetermined set humidity in accordance with the measured results if the measured humidity in the nozzles and/or on the nozzle face is different from the set humidity. In this case, the maintenance assembly may be readily coupled/separated to/from the inkjet head 11 such that the maintenance for the inkjet head may be easily performed. Further, the temperature and the humidity of the nozzles and the temperature and the humidity of the nozzle face may be advantageously adjusted by providing the humidity control fluid onto the nozzles and the nozzle face. Moreover, the remaining chemical liquid or the falling chemical liquid droplets may be collected from the nozzles and the nozzle face so that the maintenance for the inkjet head may be more efficiently carried out.

### BRIEF DESCRIPTION OF THE DRAWINGS

Example embodiments will be more clearly understood from the following detailed description taken in conjunction with the accompanying drawing. The following figures represent non-limiting, example embodiments as described herein.

FIGS. 1 and 2 are schematic cross-sectional views illustrating an apparatus for processing a substrate including a maintenance assembly for an inkjet head in accordance with example embodiments of the invention.

FIG. 3 is a schematic plan view illustrating an inkjet head having a nozzle face in accordance with example embodiments of the invention.

### DESCRIPTION OF EMBODIMENTS

Various embodiments will be described more fully hereinafter with reference to the accompanying drawings, in which some embodiments are shown. The invention may, however, be embodied in many different forms and should not be construed as limited to the embodiments set forth herein. Rather, these embodiments are provided so that this description will be thorough and complete, and will fully convey the scope of the invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (for example, rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include a plurality of forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments are described herein with reference to cross-sectional illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the face through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be described with reference to the accompanying drawings.

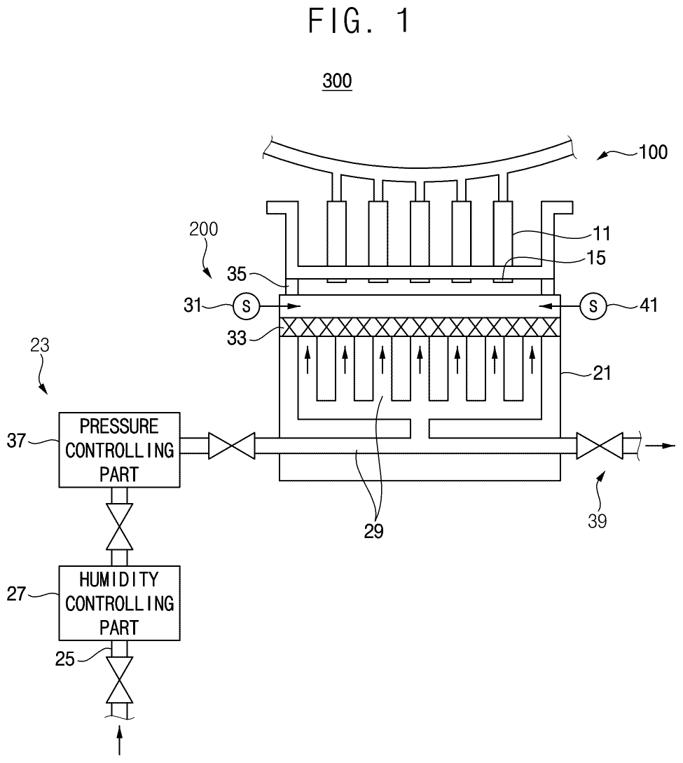

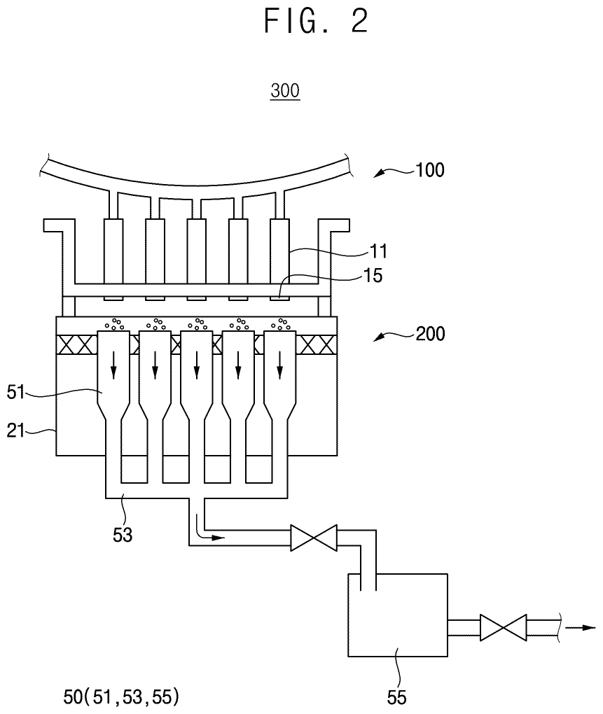

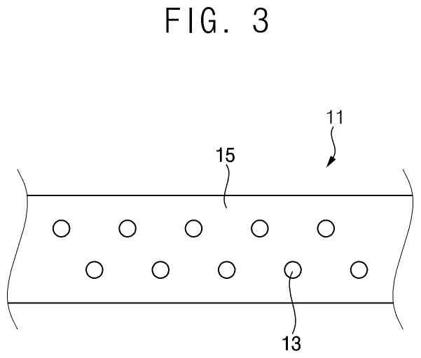

FIGS. 1 and 2 are schematic cross-sectional views illustrating an apparatus for processing a substrate including a maintenance assembly for an inkjet head in accordance with example embodiments of the invention. FIG. 3 is a schematic plan view illustrating an inkjet head having a nozzle face in accordance with example embodiments of the invention.

Referring to FIGS. 1 to 3, an apparatus for processing a substrate 300 according to example embodiments may include a chemical liquid discharging part 100 having an inkjet head 11 and a maintenance assembly 200 for the inkjet head 11.

In the apparatus for processing a substrate 300, the inkjet head 11 of the chemical liquid discharging part 100 may discharge a predetermined chemical liquid, which may include a red (R) ink, a green (G) ink, a blue (B) inkjet head, or a photoresist, onto a substrate for manufacturing a display device such as an organic light emitting display (OLED) device or a quantum dot light emitting display (QLED) device. In some example embodiments, the apparatus for processing a substrate 300 may include a chemical liquid discharging part 100 having a plurality of inkjet heads 11 provided by the unit of pack.

The inkjet head 11 of the chemical liquid discharging part 100 may have a plurality of nozzles 13 for providing the chemical liquid onto the substrate. In example embodiments, the inkjet head 11 may have a nozzle face 15 including the plurality of nozzles 13 arranged by a substantially constant intervals.

If the chemical liquid remains in the plurality of nozzles 13 and/or on the nozzle face 15 having the arranged nozzles 13, a failure of a process for discharging the chemical liquid onto the substrate may be caused by the remaining chemical liquid. Therefore, the chemical liquid remained in the nozzles 13 and/or on the nozzle face 15 is needed to be removed or cleaned. Additionally, a surrounding environment of the chemical liquid is needed to may be properly maintained since the chemical liquid may be relatively sensitive to the surrounding environment including temperature and humidity. Furthermore, process conditions including humidity are needed to be advantageously maintained for the nozzles 13 and/or the nozzle face 15 from which the chemical liquid is discharged. In example embodiments, the maintenance assembly 200 may advantageously maintain the surrounding environment including temperature and humidity and the process conditions including temperature and humidity for the nozzles 13 of the inkjet head 11 and/or the nozzle face 15 of the inkjet head 11.

In example embodiments, the maintenance assembly 200 for the inkjet head 11 may perform maintenance about the inkjet head 11 when the chemical liquid is not discharged onto the substrate from the nozzles 13 of the inkjet head 11. For example, the maintenance assembly 200 may periodically execute the maintenance on the inkjet head 11, or may perform the maintenance about the inkjet head 11 before or after the process for discharging the chemical liquid onto the substrate.

In some example embodiments, the apparatus for processing a substrate 300 may include a stand-alone maintenance assembly 200 for the inkjet head 11. For example, the maintenance assembly 200 may be coupled to the inkjet head 11 when the maintenance assembly 200 performed the maintenance about the inkjet head 11.

As illustrated in FIG. 1, the maintenance assembly 200 for the inkjet head 11 may include a housing 21, a fluid supplying part 23, a humidity sensing part 31, a fluid distributing part 33, a guide part 35, a pressure controlling part 37, a fluid discharging part 39, an oxygen sensing part 41, and a chemical liquid collecting part 50.

The housing 21 may substantially face the nozzle face 15 of the inkjet head 11 from which the chemical liquid is discharged onto the substrate. That is, the housing 21 may have an upper face substantially corresponding to the nozzles 13 and the nozzle face 15. For example, the housing 21 may have a substantial box structure.

The upper face of the housing 21 may have a size partially covering the inkjet head 11 or may have a size entirely covering the inkjet head 11. Alternatively, the upper face of the housing 21 may have a size entirely covering the chemical liquid discharging part 100 including a plurality of inkjet head 11 provided by the pack unit.

If the upper face of the housing 21 has the size partially covering the inkjet head 11, the maintenance may be performed on a portion of the inkjet head 11 by the maintenance assembly 200 so that the maintenances may be executed several times on the entire inkjet head 11. When the upper face of the housing 21 has the size entirely covering the inkjet head 11, the maintenance assembly 200 may substantially perform the maintenance on the entire inkjet head 11 once.

When the upper face of the housing 21 has the size covering the portion of the inkjet head 11, the maintenance assembly 200 may more carefully perform the maintenance about the entire inkjet head 11 or the plurality of inkjet heads 11 although the maintenance assembly 200 may repeatedly carried out the maintenance. If the upper face of the housing 21 has the size entirely covering the inkjet head 11 or the plurality of inkjet heads 11, time of the maintenance for the entire inkjet head 11 or the plurality of inkjet heads 11 may be shortened.

As described above, in the example embodiments, the maintenance assembly 200 for the inkjet head 11 may advantageously perform the maintenance about the inkjet head(s) 11 considering the size of the inkjet head 11, the number of the inkjet heads 11, the condition of the nozzles 13 and/or the condition of the nozzle face 15 by adjusting the size of the upper face of the housing 21 thereof.

The fluid supplying part 23 may regulate the surrounding environment including the temperature and the humidity around the nozzles 13 and the nozzle face 15. In example embodiments, the fluid supplying part 23 may adjust the humidity around the nozzles 13 and the nozzle face 15 of the inkjet head 11 using a humidity control fluid. The fluid supplying part 23 may provide the humidity control fluid onto the nozzles 13 and the nozzle face 15 through the upper face of the housing 21.

The fluid supplying part 23 may adjust the humidity in the nozzles 13 and/or on the nozzle face 15 as a predetermined set humidity. In particular, if the humidity in the nozzles 13 and/or on the nozzle face 15 is different from the set humidity, the fluid supplying part 23 may provide the humidity control fluid onto the nozzles 13 and the nozzle face 15 though the upper face of the housing 21.

In example embodiments, the fluid supplying part 23 may include an inflow line 25, a humidity controlling part 27 and a supply line 29. The humidity control fluid may be provided from an external source (not illustrated) through the inflow line 25. The humidity controlling part 27 may enable the humidity control fluid supplied through the inflow line 25 to have the set humidity. The humidity control fluid having the set humidity by the humidity controlling part 27 may be provided onto the nozzles 13 and the nozzle face 15 through the supply line 29. The inflow line 25 may be disposed at an outside of the housing 21 whereas the supply line 29 may be positioned in the housing 21. The inflow line 25 may be connected to the supply line 29 at a side of the housing 21 or at a bottom of the housing 21.

In example embodiments, the humidity controlling part 27 may include a heater for heating the humidity control fluid such that the humidity control fluid provided through the inflow line 25 may have the set humidity. Further, the humidity controlling part 27 may heat the humidity control fluid so that the humidity control fluid may have a temperature of set process conditions. That is, the humidity controlling part 27 may regulate the temperature and the humidity of the humidity control fluid so that the temperature and the humidity of the humidity control fluid may match the set temperature and the set humidity. The maintenance assembly 200 for the inkjet head 11 may efficiently perform the maintenance assembly including temperature and humidity about the nozzles 13 and the nozzle face 15 because the temperature and the humidity of the humidity control fluid may be adjusted using the humidity controlling part 27.

Referring now to FIG. 1 to FIG. 3, the humidity sensing part 31 may sense and measure the humidity in the nozzles 13 and/or on the nozzle face 15 of the inkjet head 11. Here, the humidity sensing part 31 may be generally adjacent to the nozzles 13 and the nozzle face of the inkjet head 11.

In example embodiments, the humidity controlling part 27 may regulate the amount, the temperature and/or the humidity of the humidity control fluid in accordance with the measured results in which the humidity sensing part 25 measures the humidity of the nozzles 13 and/or the humidity of the nozzle face 15. For example, the humidity controlling part 27 may change the temperature of the humidity control fluid in accordance with the measured results by the humidity sensing part 25. If the humidity of the nozzles 13 and/or the humidity of the nozzle face 15 measured by the humidity sensing part 31 is lower or higher than the set humidity, the supply adjusting part 36 may change the temperature, the humidity and/or the amount of the humidity control fluid provided around the nozzles 13 and the nozzle face 15 so that the humidity of the nozzles 13 and/or the humidity of the nozzle face 15 may be substantially equal to the set humidity.

In example embodiments, the humidity sensing part 31 may continuously sense and measure the humidity of the nozzles 13 and the nozzle face 15 of the inkjet head 11, and the humidity controlling 27 may regulate the temperature, the humidity and/or the amount of the humidity control fluid provided around the nozzles 13 and the nozzle face 15 in accordance with the results measured by the humidity sensing part 31. Therefore, the maintenance assembly 200 for the inkjet head 11 may consistently maintain the set humidity with respect to the nozzles 13 and/or the nozzle face 15.

The fluid distributing part 33 may substantially uniformly distribute the atmosphere including humidity formed using the humidity control agent around the nozzles 13 and the nozzle face 15 of the inkjet head 11. To this end, the fluid distributing part 33 may be disposed over the supply line 29 through which the humidity control fluid passes. If the supply line 29 is positioned in the housing 21, the fluid distributing part 33 may be disposed over the supply line 29 in the housing 21. In example embodiments, the fluid distributing part 33 may have a mesh structure including pores arranged by substantially constant distances so that the humidity control fluid provided from the supply line 29 may be substantially uniformly distributed around the nozzles 13 and the nozzle face 15. In this case, each pore of the fluid distributing part 33 may have a size which may not enable chemical liquid droplets falling from the nozzles 13 and/or the nozzle face 15 to pass therethrough. The humidity control fluid may be substantially uniformly distributed around the nozzles 13 and the nozzle face 15 of the inkjet head 11 using the fluid distributing part 33 so that the maintenance assembly 200 may more efficiently maintain the inkjet head 11 having the nozzles 13 and the nozzle face 15.

In performing the maintenance about the inkjet head 11 using the maintenance assembly 200, the humidity control fluid may not be provided around the nozzles 13 and the nozzle face 15 if the upper face of the housing 21 makes contact with the nozzle face 15 and/or the nozzles 13. Further, if the upper face of the housing 21 is very close to the nozzle face 15 and/or the nozzles 13, the humidity control fluid may not be uniformly distributed around the entire nozzles 13 and the nozzle face 15. Considering these problems, the maintenance assembly 200 may include a guide part 35 which may keep a substantially constant distance among the upper face of the housing 21 and the nozzles 13 and/or the nozzle face 15. The guide part 35 may have a fence structure surrounding the upper face of the housing 21 such that the upper face of the housing 21 may be separated from the nozzles 13 and/or the nozzle face 15 by the substantially constant distance. In this case, the guide part 35 may enable the upper face of the housing 21 to sufficiently close to the nozzle face 15 of the inkjet head 11 so that the humidity control fluid may not be leaked from the upper face of the housing 21 and the nozzle face 15. Using the guide part 35, the maintenance assembly 200 may more effectively maintain the inkjet head 11 having the nozzles 13 and the nozzle face 15.

Since the guide part 35 may keep the upper face of the housing 21 to sufficiently close to the nozzle face 15 of the inkjet head 11, the pressure of the fluid supplying part 23 may continuously increase when the humidity control fluid is constantly provided around the nozzles 13 and the nozzle face 15. Here, the nozzles 13 and/or the nozzle face 15 of the inkjet head 11 may be damaged by the increased pressure. In particular, when the humidity control fluid having a predetermined pressure is provided onto the nozzles 13 and the nozzle face 15, the nozzles 13 and/or the nozzle face 15 may be considerably damaged. To prevent the damages to the nozzles 13 and/or the damage to the nozzle face 15 by the increased pressure and/or the humidity control fluid, the pressure controlling part 39 may adjust the pressure of the humidity control fluid and the fluid discharging part 39 may discharge the humidity control fluid from the nozzles 13 and the nozzle face 15 to the outside. For example, the fluid discharging part 39 may discharge the humidity control fluid in a vacuum suction manner. The pressure controlling part 39 may keep the humidity control fluid to be substantially constant during continuously providing of the humidity control fluid onto the nozzles 13 and the nozzle face 15. In example embodiments, the fluid discharging 39 may partially discharge the humidity control fluid to the outside so that the increased pressure applied to the nozzle face 15 of the inkjet head 11 may be reduced. The maintenance assembly 200 for the inkjet head 11 may continuously provide the humidity control fluid onto the nozzles 13 and the nozzle face 15 while maintaining the sufficient close distance between the upper face of the housing 21 and the nozzle face 15 and also preventing the damages to the nozzles 13 and/or the damage to the nozzle face 15 using the pressure controlling part 37 and the fluid discharging part 39. Therefore, the efficiency of the maintenance of the inkjet head 11 performed by the maintenance assembly 200 may be more improved.

In example embodiments, the humidity control fluid may include a gas. For example, the humidity control fluid may include an oxygen gas, a nitrogen gas, a clean dried air, or the combinations thereof.

Referring now FIG. 1 to FIG. 3, the oxygen sensing part 41 of the maintenance assembly 200 may sense and measure an amount of oxygen in the humidity control fluid over the nozzles 13 and/or the nozzle face 15 of the inkjet head 11. The amount of the humidity control fluid provided over the nozzles 13 and the nozzle face 15 may be adjusted in accordance with the results measured by the oxygen sensing part 41. The oxygen sensing part 41 may maintain the amount of oxygen in the humidity control fluid over the nozzles 13 and the nozzle face 15 within a predetermined set range thorough the adjustment of the amount of the humidity control fluid using the fluid supplying part 23 if the measured amount of oxygen deviates from the predetermined set range.

In some example embodiments, the oxygen sensing part 41 may be replaced with a nitrogen sensing part when the humidity control fluid including the nitrogen gas is provided onto the nozzles 13 and the nozzle face 15. However, the humidity control fluid may include various gases if the surrounding environment including temperature and humidity is properly generated around the nozzles 13 and the nozzle face 15.

Using the oxygen sensing part 41, the amount of oxygen in the humidity control fluid provided over the nozzles 13 and the nozzle face 15 may be measured and the amount of oxygen in the humidity control fluid may be maintained within the set range such that the humidity control fluid may be more exactly adjusted. Therefore, the efficiency of the maintenance of the inkjet head 11 performed by the maintenance assembly 200 may be more enhanced. As a result, the maintenance assembly 200 for the inkjet head 11 may more exactly meet the process conditions in which the chemical liquid sensitive to the surrounding environment including temperature and humidity, and easily deteriorated, for example, the chemical liquid including the red inkjet head, the green inkjet head, the blue inkjet head or the photoresist for manufacturing the display device is used.

While performing the maintenance of the inkjet head 11 using the maintenance assembly 200, the chemical liquid droplets remaining in the nozzles 13 and/or on the nozzle face 15 may frequently fall onto the maintenance assembly 200. If the falling chemical liquid droplets flows into the supply line 29, the humidity control fluid may not be properly provided by the fluid supplying part 23 over the nozzles 13 and the nozzle face 15 as well as a failure of the fluid supplying part 23 may be caused. Considering these problems, the chemical liquid collecting part 50 may collect the chemical liquid remaining in the nozzles 13 and/or on the nozzle face 15, or the chemical liquid droplets falling from the inkjet head 11. For example, the chemical liquid collecting part 50 may collect the remaining chemical liquid or the falling chemical liquid droplets in a vacuum suction manner. In example embodiments, the chemical liquid collecting part 50 may easily collect the remaining chemical liquid or the falling chemical liquid droplets even though the remaining chemical liquid or the falling chemical liquid droplets are scattered from the nozzles 13 and/or the nozzle face 15 by the humidity control fluid.

The chemical liquid collecting part 50 may include a chemical liquid receiving part 51, a connection line 53 and a chemical liquid discharge part 55. The chemical liquid receiving part 51 may collect the remaining chemical liquid or the falling chemical liquid droplets from the nozzles 13 and/or the nozzle face 15. The connection line 53 may be coupled to the chemical liquid receiving part 51 and the chemical liquid discharge part 55. The chemical liquid discharge part 55 may temporarily store the chemical liquid from the chemical liquid receiving part 51 and may discharge the stored chemical liquid to an outside.

The chemical liquid receiving part 51 and the connection line 53 may be disposed in an inside of the housing 21 whereas the chemical liquid discharge part 55 may be positioned at an outside of the housing 21. The chemical liquid receiving part 51 may have a size substantially corresponding to the size of the nozzle face 15 of the inkjet head 11. Alternatively, the chemical liquid receiving part 51 may have a size substantially corresponding to each of the plurality of inkjet heads 11 provided by the pack unit. If the apparatus for processing a substrate 300 includes the plurality of inkjet heads 11 provided by the pack unit, the chemical liquid collecting part 50 may include a plurality of chemical liquid receiving parts 51, a plurality of branched connection lines coupled to the plurality of chemical liquid receiving parts 51, and one connection line connected to the plurality of branched connection lines.

In example embodiments, the chemical liquid collecting part 50 may include a vacuum pump capable of collecting the remaining chemical liquid or the falling chemical liquid droplets from the nozzles 13 and the nozzle face 15. Here, the vacuum pump may be adjacent to the chemical liquid receiving part 51, or may be adjacent to the chemical liquid discharge part 55. If the chemical liquid receiving part 51 has an inlet lower than the supply line 29, the falling chemical liquid droplets from the nozzles 13 and the nozzle face 15 may directly flow into the supply line 29. Considering this problem, the inlet of the chemical liquid receiving part 51 may be positioned higher than the supply line 29. Additionally, the inlet of the chemical liquid receiving part 51 may be located higher than the fluid part 33. Therefore, the chemical liquid or the chemical liquid droplets not collected into the chemical liquid receiving part 51 may not directly flow into the supply line 29 by the fluid distributing part 33.

According to example embodiments, when the process for discharging the chemical liquid onto the substrate from the inkjet head 11 is not performed, the maintenance assembly 200 for the inkjet head 11 may perform the maintenance to the inkjet head 11 so that the nozzles 13 and/or the nozzle face 15 may have the predetermined set humidity. In particular, the humidity in the nozzles 13 and/or on the nozzle face 15 of the inkjet head 11 may be measured, and the humidity in the nozzles 13 and/or on the nozzle face 15 may be adjusted to the predetermined set humidity in accordance with the measured results if the measured humidity in the nozzles 13 and/or on the nozzle face 15 is different from the set humidity. In this case, the maintenance assembly 200 may be readily coupled/separated to/from the inkjet head 11 such that the maintenance for the inkjet head 11 may be easily performed. Further, the temperature and the humidity of the nozzles 13 and the temperature and the humidity of the nozzle face 15 may be advantageously adjusted by providing the humidity control fluid onto the nozzles 13 and the nozzle face 15. Moreover, the remaining chemical liquid or the falling chemical liquid droplets may be collected from the nozzles 13 and the nozzle face 15 so that the maintenance for the inkjet head 11 may be more efficiently carried out.

In the apparatus for processing a substrate 300 including the maintenance assembly 200 according to example embodiments, the surrounding environment including temperature and humidity relative to the nozzles 13 and the nozzles may be effectively maintained, and thus the failure of the process for discharging the chemical liquid onto the substrate may be prevented. The maintenance method using such maintenance assembly 200 and the apparatus for processing a substrate 300 having the maintenance assembly 200 may be advantageously employed in manufacturing the display device such as the organic light emitting display or the quantum dot light emitting display.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the invention. Accordingly, all such modifications are intended to be included within the scope of the invention as defined in the claims. In the claims, means-plus-function clauses are intended to cover the structures described herein as performing the recited function and not only structural equivalents but also equivalent structures. Therefore, it is to be understood that the foregoing is illustrative of various embodiments and is not to be construed as limited to the specific embodiments disclosed, and that modifications to the disclosed embodiments, as well as other embodiments, are intended to be included within the scope of the appended claims.

What is claimed is:

1. A maintenance assembly for an inkjet head, which comprises:
a housing having an upper face facing a nozzle face on which nozzles for discharging a chemical liquid on a substrate are arranged; and
a fluid supplying part for providing a humidity control fluid onto the nozzles and the nozzle face such that a humidity of the nozzles and a humidity of the nozzle face are adjusted to a set humidity if the humidity of the nozzles and the humidity of the nozzle face are different from the set humidity.

2. The maintenance assembly for an inkjet head of claim 1, wherein the fluid supplying part includes an inflow line through which the humidity control fluid is provided from an external source, a humidity controlling part for enabling the humidity control fluid to have the set humidity, and a supply line for providing the humidity control fluid having the set humidity onto the nozzles and the nozzle face.

3. The maintenance assembly for an inkjet head of claim 2, wherein the humidity controlling part includes a heater for heating the humidity control fluid.

4. The maintenance assembly for an inkjet head of claim 2, further comprising a humidity sensing part for measuring the humidity of the nozzles and the humidity of the nozzle face, wherein the humidity controlling part adjusts the humidity of the humidity control fluid in accordance with results measured by the humidity sensing part.

5. The maintenance assembly for an inkjet head of claim 1, further comprising a fluid distributing part for uniformly distributing the humidity control fluid over the nozzles and the nozzle face wherein the atmosphere distributing part has a mesh structure.

6. The maintenance assembly for an inkjet head of claim 1, further comprising a guide part for maintaining a constant distance between the upper face of the housing and the nozzle face.

7. The maintenance assembly for an inkjet head of claim 1, further comprising a pressure controlling part for adjusting a pressure of the humidity control fluid, and a fluid discharging part for discharging the humidity control fluid to an outside.

8. The maintenance assembly for an inkjet head of claim 1, wherein the humidity control fluid is selected from an oxygen gas, a nitrogen gas, a clean dried air and combinations thereof, the maintenance assembly further comprises an oxygen sensing part for measuring an amount of oxygen in the humidity control fluid over the nozzles and the nozzle face, and an amount of the humidity control fluid provided onto the nozzles and the nozzle face is adjusted in accordance with results measured by the oxygen sensing part.

9. The maintenance assembly for an inkjet head of claim 1, further comprising a chemical liquid collecting part for collecting a remaining chemical liquid or a falling chemical liquid from the nozzles and the nozzle face in a vacuum suction manner.

10. The maintenance assembly for an inkjet head of claim 9, wherein the chemical liquid collecting part includes a chemical liquid receiving part for receiving the remaining chemical liquid or the falling chemical liquid, a chemical liquid discharging part for temporally storing and discharging the remaining chemical liquid or the falling chemical liquid, and a connection line coupled to the chemical liquid receiving part and the chemical liquid discharging part.

11. A maintenance method for an inkjet head, which comprises:
measuring a humidity of nozzles for discharging chemical liquid onto a substrate and a humidity of a nozzle face on which the nozzles are arranged; and
adjusting the humidity of the nozzles and the humidity of the nozzle face to a set humidity if the measured humidity of the nozzles and the measured humidity of the nozzle face ate different from the set humidity.

12. The maintenance method for an inkjet head of claim 11, wherein the adjusting of the humidity of the nozzles and the humidity of the nozzle face comprises providing a humidity control fluid onto the nozzles and the nozzle face, a humidity of humidity control fluid is controlled by heating the humidity control fluid and/or by adjusting an amount of the humidity control fluid, and the humidity control fluid is selected from an oxygen gas, a nitrogen gas, a clean dried air and combinations thereof.

13. The maintenance method for an inkjet head of claim 11, further comprising collecting a remaining chemical liquid or a falling chemical liquid from the nozzles and the nozzle face in a vacuum suction manner.

14. The maintenance method for an inkjet head of claim 11, wherein the adjusting of the humidity of the nozzles and the humidity of the nozzle face is performed when the nozzles do not discharge the chemical liquid onto the substrate.

15. An apparatus for processing a substrate comprising:
an inkjet head having a nozzle face on which nozzles for discharging a chemical liquid onto a substrate are arranged; and
a maintenance assembly for performing a maintenance to the inkjet head, the maintenance assembly comprising:
a housing having an upper face facing the nozzle face; and
a fluid supplying part for providing a humidity control fluid onto the nozzles and the nozzle face such that a humidity of the nozzles and a humidity of the nozzle face are adjusted to a set humidity if the humidity of the nozzles and the humidity of the nozzle face are different from the set humidity.

16. The apparatus for processing a substrate of claim 15, wherein the fluid supplying part includes an inflow line through which the humidity control fluid is provided from an external source, a humidity controlling part for enabling the humidity control fluid to have the set humidity, and a supply line for providing the humidity control fluid having the set humidity onto the nozzles and the nozzle face.

17. The apparatus for processing a substrate of claim 16, further comprising a humidity sensing part for measuring the humidity of the nozzles and the humidity of the nozzle face, wherein the humidity controlling part adjusts the humidity of the humidity control fluid in accordance with results measured by the humidity sensing part.

18. The apparatus for processing a substrate of claim 15, further comprising:
a fluid distributing part for uniformly distributing the humidity control fluid over the nozzles and the nozzle face wherein the atmosphere distributing part has a mesh structure;
a guide part for maintaining a constant distance between the upper face of the housing and the nozzle face;
a pressure controlling part for adjusting a pressure of the humidity control fluid; and
a fluid discharging part for discharging the humidity control fluid to an outside.

19. The apparatus for processing a substrate of claim 15, wherein the humidity control fluid is selected from an oxygen gas, a nitrogen gas, a clean dried air and combinations thereof, the maintenance assembly further comprises an oxygen sensing part for measuring an amount of oxygen in the humidity control fluid over the nozzles and the nozzle face, and an amount of the humidity control fluid provided onto the nozzles and the nozzle face is adjusted in accordance with results measured by the oxygen sensing part.

20. The apparatus for processing a substrate of claim 15, further comprising a chemical liquid collecting part for collecting a remaining chemical liquid or a falling chemical liquid from the nozzles and the nozzle face in a vacuum suction manner, wherein the chemical liquid collecting part includes a chemical liquid receiving part for receiving the remaining chemical liquid or the falling chemical liquid, a chemical liquid discharging part for temporally storing and discharging the remaining chemical liquid or the falling chemical liquid, and a connection line coupled to the chemical liquid receiving part and the chemical liquid discharging part.
